(19) United States
(12) Patent Application Publication
(10) Pub. No.: US 2013/0119775 A1
(43) Pub. Date: May 16, 2013

(54) Contactless system for reading information on a card

(71) Applicants: Marc Lepage, Saclas (FR); Dominique Mocquard, Paris (FR)

(72) Inventors: Marc Lepage, Saclas (FR); Dominique Mocquard, Paris (FR)

(21) Appl. No.: 13/587,519

(22) Filed: Aug. 16, 2012

(30) Foreign Application Priority Data
Aug. 16, 2011 (FR) FR 1157350

(51) Int. Cl. G06K 19/07; H02J 17/00

(52) U.S. Cl. CPC G06K 19/0709; H02J 17/00
USPC 307/104; 235/492

(57) ABSTRACT

Contactless reading device (10, 20) comprising transmission-reception means (11), and a power supply circuit (12) for the transmission-reception means (11), characterized in that the power supply circuit (12) comprises a magnetic contactor (13, 23) having a nominal open position preventing the powering of the transmission-reception means (11) and a closed position enabling the powering of the transmission-reception means (11), the magnetic contactor (13, 23) being in the closed position when an identification card (1) according to one of claims 1 to 3 nears the reading device (10, 20).

The invention relates, generally, to the management of electrical energy on board a motor vehicle, and more particularly the management of the electrical energy of a motor vehicle in car sharing and in parking.

It appears that the use of a car sharing system for motor vehicles with at least partial electrical traction significantly increases the electrical consumption of the motor vehicle when it is in parking mode, particularly when the vehicle is waiting to be leased by a user.

This electrical overconsumption of the motor vehicle when stopped frequently results in battery failures, particularly in the case where the vehicle is used little or not at all over a period varying between 2 to 5 days, depending on the types of motor vehicles.

The same phenomenon is observed regardless of whether the motor vehicle has full electrical traction, partial electrical traction or even heat traction.

The energy overconsumption of the motor vehicles in car sharing is due mainly to the management of the user validation process, and in particular to the permanent energy consumption of the radio frequency identification system (RFID) used to read the badges of the users.

The invention aims to mitigate the abovementioned drawbacks by proposing an identification system which is activated only when an identification card nears a reading device.

According to one aspect, in one embodiment, a contactless identification card is proposed comprising a substrate, an integrated electronic circuit in which are loaded identification data of the card and/or of the holder of the card and an antenna coupled to the integrated circuit for the transmission of data to a contactless reading device.

According to a general feature, the identification card comprises a metal part placed on the substrate to control the displacement of a magnetic contactor of the reading device.

The metal part makes it possible to actuate the reading device and, more particularly, the powering of the reading device.

Preferably, the metal part is integrated in the substrate and insulated from the antenna.

The insulation of the metal part from the antenna makes it possible to avoid any disturbance from the transmission or the reception of data by the antenna. The integration of the metal part in the identification card, for example by overmoulding of plastic material so as to envelope the metal part, makes it possible to reduce the risks of the metal part being separated from the card. It has been found that, when the metal part is glued to a plastic surface of the card, the overthickness created by the metal part offers an attachment which can lead, with time, to a detachment of the metal part.

Advantageously, the card can comprise storage means coupled to the integrated electronic circuit.

The storage means, such as an EEPROM-type memory, can be used to retain in memory different information stored in a log, prepayment means making it possible to ascertain the balance available on the card. The storage means thus make it possible to contain information usually available on a network, and thus reduce the energy consumption to obtain such information.

According to another aspect, a contactless reading device is proposed which comprises transmission-reception means, and a power supply circuit for the transmission-reception means.

According to a general feature, the power supply circuit comprises a magnetic contactor having a nominal open position preventing the powering of the transmission-reception means and a closed position enabling the powering of the transmission-reception means, the magnetic contactor being in the closed position when an identification card as defined above nears the reading device.

Thus, in the absence of an identification card as described above, the reading device remains disconnected from the power supply circuit, avoiding any electrical energy consumption. The autonomy of the vehicle is thus increased.

The magnetic contactor may comprise a magnet and elastic means capable of stressing the electrical contactor into the nominal open position.

The magnetic contactor may comprise a magnetic switch capable of switching from the nominal open position in the presence of a magnetic field generated by the magnet to the closed position in the absence of magnetic field generated by the magnet, the magnet moving away from the magnetic switch when the identification card nears the reading device.

The magnetic switch may, for example, be a flexible plate switch (also known as REED switch).

In a variant, the contactor may comprise an electrical contact mounted on the magnet and capable of being coupled to two portions of the power supply circuit so as to close the power supply circuit when the identification card nears the reading device. The electrical contact is thus maintained by the elastic means at a distance from the two portions of the power supply circuit so as to keep the circuit open and prevent a current from flowing in the power supply circuit. When an identification card as defined above nears, the metal part of the identification card interacts with the magnet, the magnetic force established then compressing the elastic means until the contactor is in contact with the two portions of the power supply circuit enabling the circulation of a current in the power supply circuit and the powering of the reading device.

According to another aspect, in one implementation, a contactless reading method is proposed comprising the powering of transmission-reception means of a contactless reading device using a power supply circuit.

According to a general feature, the power supply circuit is powered only when a contactless identification card nears the reading device.

Preferably, the power supply circuit is closed so as to allow the circulation of an electrical current when the identification card is positioned in relation to the reading device in such a way as to create a magnetic coupling between the identification card and a magnetic contactor of the reading device.

The magnetic contactor is, preferably, configured so that the contactless communication set up between the transmission-reception means and an antenna of the identification card is free of disturbances due to the magnetic coupling between the identification card and the magnetic contactor.

Other advantages and features of the invention will become apparent from examining the detailed description of embodiments, which are in no way limiting, and the appended drawings in which:

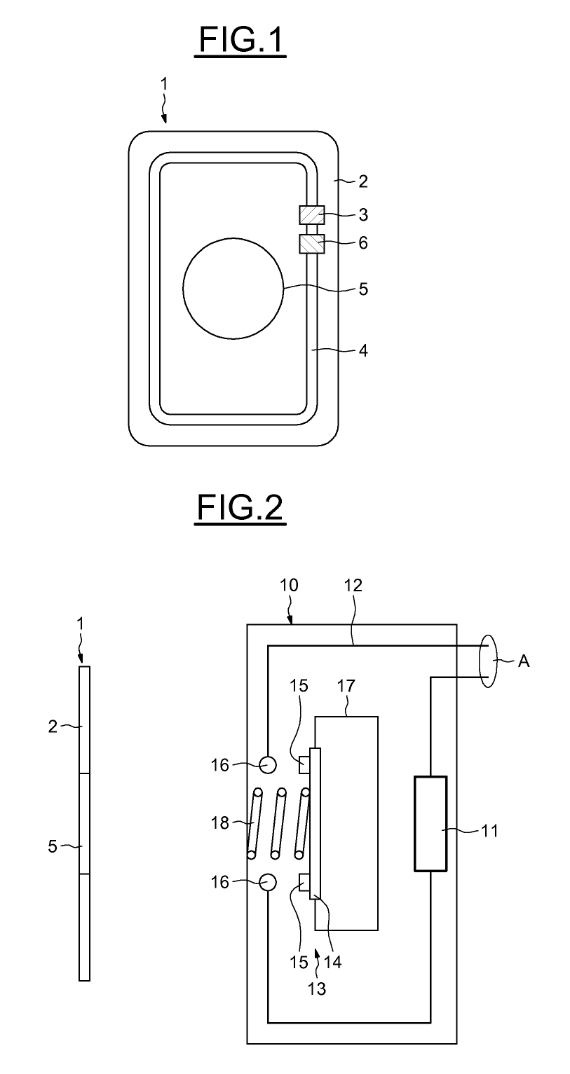

FIG. 1 schematically represents an identification card according to one embodiment;

FIG. 2 schematically illustrates a contactless reading device according to a first embodiment intended for the reading of an identification card of FIG. 1;

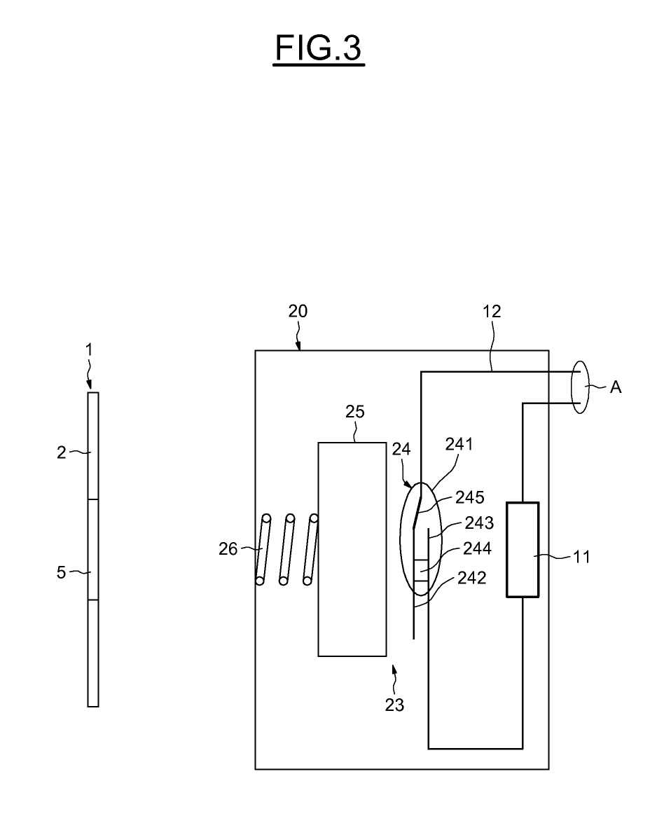

FIG. 3 schematically presents a contactless reading device according to a second embodiment intended for the reading of an identification card of FIG. 1.

FIG. 1 schematically represents a contactless identification card 1 according to one embodiment.

The contactless identification card 1 comprises a substrate 2 preferably made of insulating material, for example of plastic material, on which is arranged an integrated electronic circuit 3 and an antenna 4. The integrated circuit 3 is produced, in this example, in the form of an electronic chip.

The integrated circuit 3 is used to load identification data of the card 1 and/or of the holder of the card 1. These data are specific to the card and are stored in memory of the integrated circuit 3, in a ROM type memory.

The antenna 4 makes it possible to transmit the data from the integrated circuit 3 to a reading device 10 or 20 such as those illustrated in FIGS. 2 and 3. The antenna 4 is, for example, formed by a copper winding. It is fixed to the substrate 2 and coupled to the integrated circuit 3. The contactless identification card 1 also comprises a metal part 5 or, generally, a magnetic material, making it possible to actuate the reading device 10 or 20.

The identification card 1 also comprises in this embodiment an electrically erasable and programmable read-only memory (EEPROM or flash) 6 mounted on the card 1 and connected to the antenna 4 and to the integrated circuit 3. The memory 6 can store information relating to the identification of the user, a log of the transactions or actions performed previously, and prepayment data.

In this embodiment, the identification card 1 is produced in such a way that the integrated circuit 3, the antenna 4, the metal part 5 and the EEPROM memory are integrated in the substrate 2 and, possibly but not necessarily, invisible to the user. This can be done by overmoulding a layer of plastic material over the surface of the substrate 2 on which the various elements are fixed. FIG. 2 schematically illustrates a first exemplary embodiment of a contactless reading device 10.

In this embodiment, the reading device 10 comprises transmission-reception means 11 and a power supply circuit 12 for the transmission-reception means 11 comprising a power supply terminal A which can be connected to a battery of a motor vehicle for example.

The power supply circuit 12 comprises a magnetic contactor 13 comprising an electrical contact 14 comprising two electrical bump contacts 15 arranged facing two portions 16 of the power supply circuit 12. The magnetic contactor 13 is configured so that, in a closed position of the magnetic contactor 13, the electrical contact 14 connects, via the electrical bump contacts 15, the two portions 16 of the power supply circuit 12 so as to close the power supply circuit 12. On the other hand, in a nominal open position of the magnetic contactor, when the electrical bump contacts 15 of the electrical contact 12 are at a distance from the electrical portions 16, the power supply circuit 12 is open, preventing any circulation of electrical current in the power supply circuit 12, and thus avoiding any unnecessary energy consumption.

To switch from the closed position to the open position, the magnetic contactor 13 comprises a magnet 17 fixed to the electrical contact 14, and a spring 18 which can stress the electrical contactor 14 into the nominal open position.

In the absence of the identification card 1 of FIG. 1, and in particular when the metal part 5 is placed at a distance, the magnetic contactor 13 is in the nominal open position. In practice, the spring 18 is decompressed and keeps the electrical bump contacts 15 of the electrical contact 14 at a distance from the two portions 16 of the power supply circuit 12, thus keeping the power supply circuit 12 open, and preventing an electrical current from being established in the power supply circuit 12.

When the identification card 1 of FIG. 1 nears the contactless reading device 10, the metal part 5 interacts with the magnetic field of the magnet 17 of the reading device 10. The magnetic interaction generated between the metal part 5 and the magnet 17 causes a magnetic force to appear, attracting the magnet 17 towards the metal part of the card 1. In this embodiment, the spring 18 is arranged between the magnet 17 and the card 1, so that the magnetic force generated causes the spring 18 to be compressed until the magnetic contactor 13 is in the closed position, in which the electrical bump contacts 15 of the electrical contact 13 are in contact with the two portions 16 of the power supply circuit 12. In this closed position, a current circulates in the power supply circuit 12, thus enabling the transmission-reception means 11 of the reading device 10 to communicate with the identification card 1 via the antenna 4 of the card 1.

It can be seen therefore that the power supply circuit 12 is closed only when the card 1 nears the reading device 10.

In another embodiment, the magnet can be arranged between the two portions of the power supply circuit and a spring, and the two portions between the card 1 and the magnet. In this embodiment, the spring is configured so that the magnetic interaction between the magnet and the metal part of the card 1 causes an elongation of the spring until the electrical contact is in contact with the two portions of the power supply circuit.

FIG. 3 schematically shows a second exemplary embodiment of a contactless reading device 20. The elements that are identical to those of FIG. 2 have the same references.

In this second exemplary embodiment, the reading device 20 comprises a magnetic contactor 23 comprising a flexible plate switch 24 (also called REED switch). A flexible plate switch 24 is a switch which makes or breaks an electrical connection depending on the presence or the absence of a magnetic field.

In this embodiment, the flexible plate switch 24 is configured so as to establish a current in the power supply circuit 12 in the absence of a magnetic field and so as to open the power supply circuit 12 in the presence of a magnetic field. The flexible plate switch 24 comprises a protective glass bulb 241 containing a non-oxidizing atmosphere, and a non-magnetic plate 242, a magnetic plate 243, an insulator 244 separating the non-magnetic plate 242 from the magnetic plate 243 and a flexible magnetic contact plate 245.

In the absence of an external magnetic field, the magnetic plate 243 magnetizes the flexible magnetic contact plate 245 so as to close the power supply circuit 12 and establish the circulation of a current. In the presence of an external magnetic field greater than the magnetic field of the magnetic plate 243 and generated on a side opposite the magnetic plate 243 relative to the non-magnetic plate 242, the flexible magnetic contact plate 245 is attracted by the magnetic force generated by the external magnetic field towards the non-magnetic plate 242. Since the non-magnetic plate 242 is in a vacuum, the power supply circuit 12 is then open and no current can circulate in the power supply circuit 12, and therefore in the transmission-reception means 11.

The magnetic contactor 23 comprises a magnet 25 fixed to a spring 26. The magnet 25 generates the external magnetic field making it possible to open the power supply circuit via the coupling of the flexible magnetic contact plate 245 to the non-magnetic plate 242. The spring 26 is configured so that, in the decompressed position, at rest, the magnet 25 is at a distance enabling the external magnetic field generated by the magnet 25 to be greater than the magnetic field generated by the magnetic plate 243, and thus keep the flexible magnetic contact plate 245 in contact with the non-magnetic plate 242, keeping the power supply circuit 12 open.

The spring 26 is configured so that, when an identification card 1 of FIG. 1 nears the reader, the spring 26 situated between the card 1 and the flexible plate switch 24 is compressed and moves the magnet 25 away from the flexible plate switch until the magnetic force of the external magnetic field generated by the magnet 25 is less than the magnetic force of the magnetic field generated by the magnetic plate 243, thus bringing the flexible magnetic contact plate into a position in contact with the magnetic plate 243 making it possible to establish the circulation of a current in the power supply circuit 12 and the powering of the transmission-reception means 11.

The identification system thus proposed thus makes it possible to establish an electrical current in the contactless reading device, only when an identification card nears a reading device.

1. Contactless identification card comprising: a substrate, an integrated electronic circuit in which are loaded identification data of the card and/or of the holder of the card, an antenna coupled to the integrated circuit for the transmission of data to a contactless reading device, and a metal part placed on the substrate to control the displacement of a magnetic contactor of the reading device.

2. Card according to claim 1, in which the metal part is integrated in the substrate and insulated from the antenna.

3. Card according to claim 1, further comprising storage means coupled to the integrated electronic circuit.

4. Contactless reading device comprising transmission-reception means, and a power supply circuit for the transmission-reception means, wherein the power supply circuit comprises a magnetic contactor having a nominal open position preventing the powering of the transmission-reception means and a closed position enabling the powering of the transmission-reception means, the magnetic contactor being in the closed position when an identification card nears the reading device, wherein the reading device comprises: a substrate, an integrated electronic circuit in which are loaded identification data of the card and/or of the holder of the card, an antenna coupled to the integrated circuit for the transmission of data to a contactless reading device, and a metal part placed on the substrate to control the displacement of a magnetic contactor of the reading device.

5. Device according to claim 4, in which the magnetic contactor comprises a magnet and elastic means capable of stressing the magnetic contactor into the nominal open position.

6. Device according to claim 5, in which the magnetic contactor comprises a magnetic switch capable of switching from the nominal open position in the presence of a magnetic field generated by the magnet to the closed position in the absence of magnetic field generated by the magnet, the magnet moving away from the magnetic switch when the identification card nears the reading device.

7. Device according to claim 5, wherein the magnetic contactor comprises an electrical contact mounted on the magnet and capable of being coupled to two portions of the power supply circuit so as to close the power supply circuit when the identification card nears the reading device.

8. Contactless reading method comprising the powering of transmission-reception means of a contactless reading device using a power supply circuit, in which the power supply circuit is powered only when a contactless identification card nears the reading device.

9. Method according to claim 8, in which the power supply circuit is closed so as to allow for the circulation of an electrical current when the identification card is positioned in relation to the reading device in such a way as to create a magnetic coupling between the identification card and a magnetic contactor of the reading device.

10. Method according to claim 9, in which the magnetic contactor is configured so that the contactless communication set up between the transmission-reception means and an antenna of the identification card is free of disturbances due to the magnetic coupling between the identification card and the magnetic contactor.

11. Card according to claim 2, further comprising storage means coupled to the integrated electronic circuit.

12. Device according to claim 4, in which the metal part is integrated in the substrate and insulated from the antenna.

13. Device according to claim 4, further comprising storage means coupled to the integrated electronic circuit.
